(19) United States
(12) Patent Application Publication
(10) Pub. No.: US 2025/0386093 A1
(43) Pub. Date: Dec. 18, 2025

(54) METHODS AND SYSTEMS FOR CAPTURING OR REVISING A STILL PHOTOGRAPH OR VIDEO OF A SUBJECT TO PRODUCE A "BEST SHOT" COMPOSITION WITH IMPROVED AESTHETIC AND ARTISTIC CHARACTERISTICS

(71) Applicant: EarthCam Inc., Upper Saddle River, NJ (US)

(72) Inventor: Brian Cury, Upper Saddle River, NJ (US)

(21) Appl. No.: 19/242,391

(22) Filed: Jun. 18, 2025

Related U.S. Application Data
(60) Provisional application No. 63/661,081, filed on Jun. 18, 2024.

(51) Int. Cl. H04N 23/60; G06T 5/50; G06T 7/68; G06T 7/90; H04N 23/695

(52) U.S. Cl. CPC H04N 23/64; G06T 5/50; H04N 23/695; G06T 7/68; G06T 7/90

(57) ABSTRACT

A method for producing an improved or “best shot” image of a subject. In various embodiments the image is improved after the capturing or filming the subject or by controlling the camera prior to shooting to ensure a quality image will be captured. In the former situation, image rubrics are developed and the image is graded against those rubrics. If the grade is below a predetermined threshold, image features (e.g., contrast, framing) are modified to raise the grade. In the latter situation, various parameters regarding the camera, subject, location, and environment are collected before the image is captured and analyzed to determine characteristics of an image captured while those parameters are extant. If the image characteristics are unacceptable, one or more of the parameters, particularly the camera parameters, are changed to improve image characteristics.

### CROSS REFERENCE TO RELATED APPLICATIONS

The present application claims priority under 35 U.S.C. 119 (e) to the provisional patent application filed on Jun. 18, 2024 and assigned application No. 63/661,081 (Attorney Docket Number 16569-008). The contents of that application are incorporated herein.

### BACKGROUND OF THE INVENTION

Cable and network television broadcasters consider viewer ratings as critically important. Advertisers continually review viewer ratings for cable and network news programs. The size of a news programs viewer ratings has a direct relationship with the amount of money an advertiser will spend for viewer spots. Higher public interest in the visual content presented by a news program generally translates to higher viewer ratings.

Generally, there is limited time from the moment an image is captured, about a news event and the time it is aired on television. Often there is insufficient time for the news program staff to compose the image so that the image can create high viewer interest and viewer ratings.

Never before, have cable and network news programs been able to rapidly compose news worthy images with very high viewer interest. Never before, have news programs been able to compose news worthy images with very high view interest compared to other news worthy images, with high viewer interest of similar news events. Never before, have news programs been able to employ image composing tools to rapidly create high viewer interest, aesthetic, and artistic news worthy images before airtime and before a competitive news program.

Many remember the days of photography with an SLR camera. Previously it was necessary to have a good SLR 30 mm camera to get great photos. It was also necessary to know about ‘f stops’, i.e. ‘f2.8’, and ISO film speed to get a good photograph. It was also necessary to know how to focus a camera lens to get a good shot of a subject object.

Now, smartphone users can take photos without knowing about ‘f stops’, film speed, or lens focusing. They simply point their smartphone and click to create the photo. The smartphone camera automatically determines the ‘f stops’, film speed, and lens focusing for the “lay person”.

However, a great photo is more than knowing ‘f stops’, ‘film speed’, or lens focusing. Presently, photographic shot composition is not automatically produced by the camera. The artistic and aesthetic qualities of a photograph determine the difference between a good image and an amazing photograph. Never before has a camera been able to automatically produce a photo with the correct ‘f stops’, ‘film speed’, lens focusing, and also with superb artistic and aesthetic qualities.

### BRIEF DESCRIPTION OF THE FIGURES

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a method for generating a client request for a best shot photograph.

FIG. 2 illustrates a method for confirming camera specifications and location data.

FIG. 3 illustrates a method for determining the aesthetic characteristics of an image or video of a subject.

FIG. 4 illustrates a method for determining whether the aesthetic characteristics of the image or the video are adequate.

FIG. 5 illustrates a method for determining the ‘rule of thirds’ within an image or video.

FIG. 6 illustrates a method for determining the ‘lead lines’ within an image or video.

FIG. 7 illustrates a method for determining the ‘symmetry’ within an image or video.

FIG. 8 illustrates a method for determining the ‘use of color’ within an image or video.

FIG. 9 illustrates a method for determining ‘framing’ within an image or video.

FIG. 10 illustrates a method for determining the ‘composition’ of an image or video.

FIG. 11 illustrates a method for revising and accepting a final image or video of a subject.

FIG. 12 illustrates a method to locate a stationary camera based on an accepted final image or video of the subject.

FIGS. 13 and 14 illustrate a method for collecting image-related parameters and adjusting camera controls responsive thereto to capture a high-quality image.

FIG. 15 illustrates a block diagram of a computer and related devices for executing the methods of the present invention.

### DETAILED DESCRIPTION OF THE INVENTION

The present invention may be understood more readily by reference to the following detailed description taken in connection with the accompanying figures and examples, which form a part of this disclosure. It is to be understood that this invention is not limited to the specific devices, methods, applications, conditions, or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any sub-combination. Further, references to values within a stated range include each and every value within that range.

The disclosures of each patent, patent application, and publication cited or described in this document are incorporated herein by reference in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the spirit and scope of the invention.

The methods and apparatuses of the present invention employ various layered techniques and processes for capturing a high-quality image (for example, an image without shadows) by adjusting certain camera controls, and for improving aesthetic and artistic qualities of the image both before and after the image has been captured (for example, a still photograph or a video). Employing the teachings of the invention, a camera user can now produce an image with superb aesthetic and artistic qualities and thereby transform an image into a great photograph.

The present invention discloses a camera, image processing equipment, instruction sets, and related methods that produce a photo with, but not limited to, optimized f stop, film speed, and focus parameters, and image properties (as described below) that combine to create a photograph with remarkable artistic and aesthetic qualities, thereby converting an image into an artistic, professional photograph.

The image subject referred to herein is not limited to a panoramic landscape, a specific object within a panoramic landscape, or a specific subject. Instead, any physical object can serve as the photograph subject.

Also, a camera is not limited to a stationary camera, mobile camera, smartphone camera, or handheld camera. Any photograph taken by any camera can be improved according to the teachings of the present invention.

And the method of revising or augmenting the original photograph (sometimes referred to herein as the parent still photograph or the parent video) is not limited to manual or automated methods, or any combination thereof, for creating the final photograph.

The methods of the invention (referred to commercially as Best Shot Processes or Best Shot Methods) store photographs and information related to the photographs in a Docu-Vault, which is a secure datastore for images and data used in the Best Shot Processes. The Docu-Vault also embeds advanced data and physical security. Data security for the Docu-Vault includes, but is not limited to, data encryption, secure socket certificates, digital authentication, access rights management with multiple authentication layers, and backup systems.

Security for the physical Docu-Vault site server includes, but is not limited to, alarmed access points, climate control devices, fire extinguishing and fire suppression devices, moisture detection and environmental control devices, limited personnel access, no external windows, and an otherwise vault-like environment.

Certain artistic and aesthetic characteristics of the image are described in the various method steps of the invention, and include, but not limited to, determining one or more of the following image characteristics.

The Rule of Thirds divides the photographic frame with two equally spaced vertical lines and two similar horizontal lines. These lines and the four points at which they intersect create regions within the frame for placing subjects and other essential photo elements. These lead lines allow a photographer to arrange elements in a photograph to help lead a viewers' eyes to the subject.

Symmetry in a photograph allows a horizon, for example, to bisect the photograph frame equally, and allows a subject to be centered within the image.

Color can be manipulated within a photograph or video so that the color is striking and stands out, thereby creating interest in the photograph.

Properly framing objects within a photograph creates a sense of drama to the viewer by viewing the subject ‘through’ a window or archway, for example.

The methods of the invention, as set forth herein, can be executed for an image, including one or more images in a plurality of images. For example, the image is analyzed relative to a symmetry criterion and a rubric score determined responsive thereto. To improve the rubric score, the image is revised or augmented to improve the score and raise it above a predetermined symmetry rubric score. Those skilled in the art are familiar with the techniques and processes employed to revise or augment an image to improve the symmetry characteristics (and other image characteristics) of the image and thus improve its rubric score.

After all images have been analyzed and evaluated according to each aesthetic and artistic property as described herein, the “best” still photographs or videos are determined based on their rubric scores. For example, the “best” photograph or video may be selected based on the total rubric score for all analyzed photographs over all analyzed image characteristics.

Alternatively, a user (sometimes referred to as a client) of the methods and system may deem one of the aesthetic and artistic photograph/video characteristics to be the most significant, e.g., symmetry within the photo. This user may then select the “best” image based only on the symmetry criteria and select the image with the highest rubric score for that characteristic.

The invention is described below with reference to each of the figures.

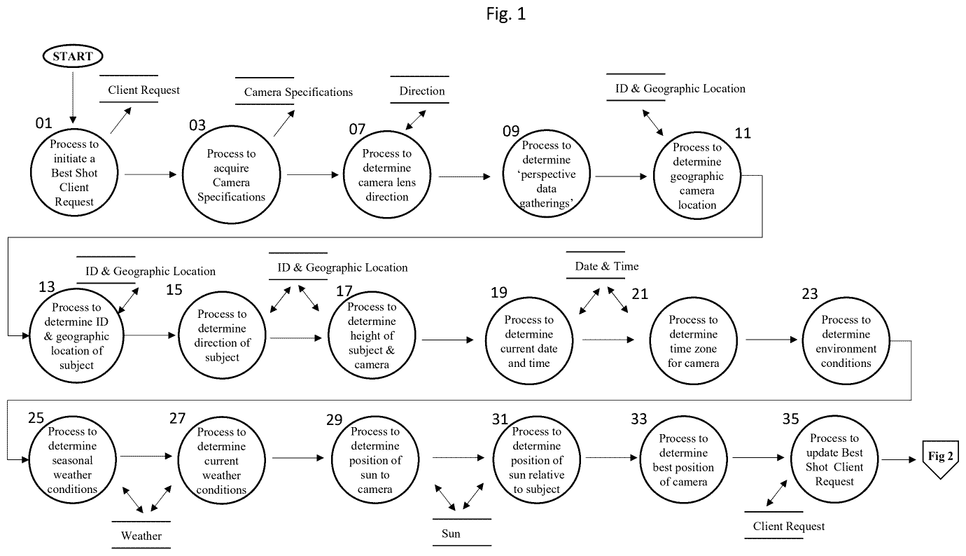

### FIG. 1: Method for Generating a Client Request for a Best Shot Photograph

As illustrated in FIG. 1, this method comprises a plurality of sub-methods or sub-processes, as set forth below, for initiating a client request to generate a best-shot photograph of an identified subject.
1. Initiating a Client Request for a Best Shot photograph or Best Shot photographs, hereinafter referred to as a ‘Client Request” and verifying that the Client is a valid subscriber to a Best Shot digital application comprising the various methods described herein. A graphical user interface may be used to facilitate the Client's Request and provide access to the digital application for generating the Best Shot photograph. The Client Request facilitates a Client capturing a “best shot” image of a subject by executing through the various method steps of the invention.

Typically, a Client Request (Form) is a record of material information about a photograph and one or more objects within the photograph, including, but not limited to, client identification information, client site identification, start and end dates and times, rubrics, selection criteria, date and time of material process events, information about material elements, but not limited to elements, of the process, and the dates and times of image chain of custody events and values. (01)
2. Acquiring specifications of the camera(s) that was used or will be used to take the photographs to be analyzed by the inventive methods and uploading the specifications to a Camera Specifications Docu-Vault. (03)
3. Establishing camera and environmental parameters, comprising:
   a. Determining the compass direction of the camera lens in degrees relative to north and uploading that determined direction to the Camera Specifications Docu-Vault. (07)
   b. Gathering data of the camera field of view as related to a best camera position. (09)
   c. Determining the specific geographic location and height of the camera above mean sea level and uploading this information to an ID & Geographic Docu-Vault. (11)
   d. Determining an identification of the image subject and the specific geographic location of the image subject. (13)
   e. Determining the compass direction of the image subject in degrees, relative to north and relative to the camera location. (15)
   f. Determining the angle of the camera lens relative to the subject by determining the distance between the camera and the image subject and determining the height of the camera relative to the height of the subject above mean sea level (17)
   g. Determining the week day and date when a photograph was taken. (19)
   h. Determining the time zone and the then-current time of day when the image was taken. (21)
   i. Determining environmental conditions at the camera location when the photo was taken, including, but not limited to the following:
      i. Seasonal weather patterns (25)
      ii. Current weather conditions including but not limited to, temperature, rain, fog, snow, temperature, wind speed, wind direction. (27)
      iii. Current position of the sun relative to the location and position of the camera location and direction of the camera lens. (29)
      iv. Current position of the sun relative to the location of the subject object. (31)
      v. The best position of the camera, direction of the lens and angle of the lens relative to the subject and the sun. (33)
   j. Updating the Client Request with the data set forth above, including additional data as set forth in the Client Request or as deemed necessary by the parties involved in securing the “Best Shot” image. (35)

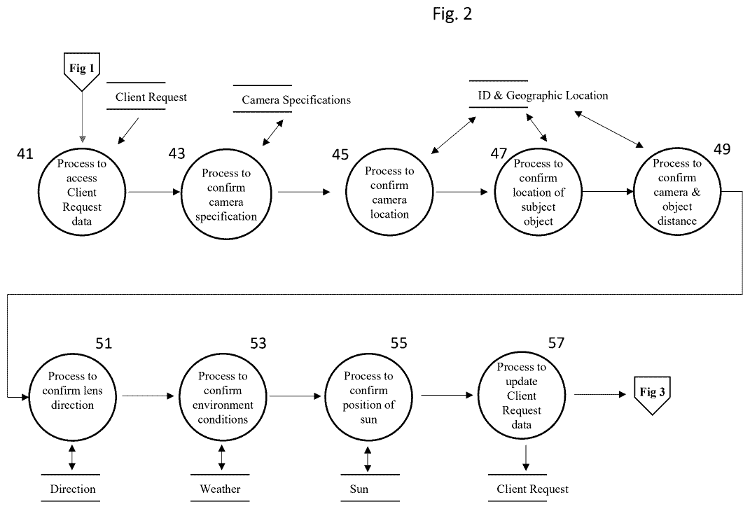

### FIG. 2: Method for Confirming Camera Specifications and Location Data

As illustrated in FIG. 2, this method comprises a plurality of sub-methods or sub-processes, as set forth below, for confirming that camera specification and location data has been obtained and is accurate.
a. Accessing camera data, location data, weather data, and sun data, etc. from the Client Request (41)
b. Confirming the geographic camera location and uploading a confirmation to the Camera Specifications Docu-Vault. (43)
c. Confirming geographic location and height of the camera and uploading a confirmation to the ID & Geographic Location Docu-Vault. (45)
d. Confirming identification, geographic location, and height of subject and uploading a confirmation to the ID & Geographic Location Docu-Vault. (47)
e. Confirming the distance between the camera and the subject and uploading a confirmation to the ID & Geographic Location Docu-Vault. (49)
f. Confirming the direction of lens and uploading a confirmation to a Direction Docu-Vault. (51)
g. Confirming the environmental conditions and uploading a confirmation to a Weather Docu-Vault. (53)
h. Confirming the position of the sun and uploading a confirmation to a Sun Docu-Vault. (55)
i. Updating the Client Request as required with additional information. (57)

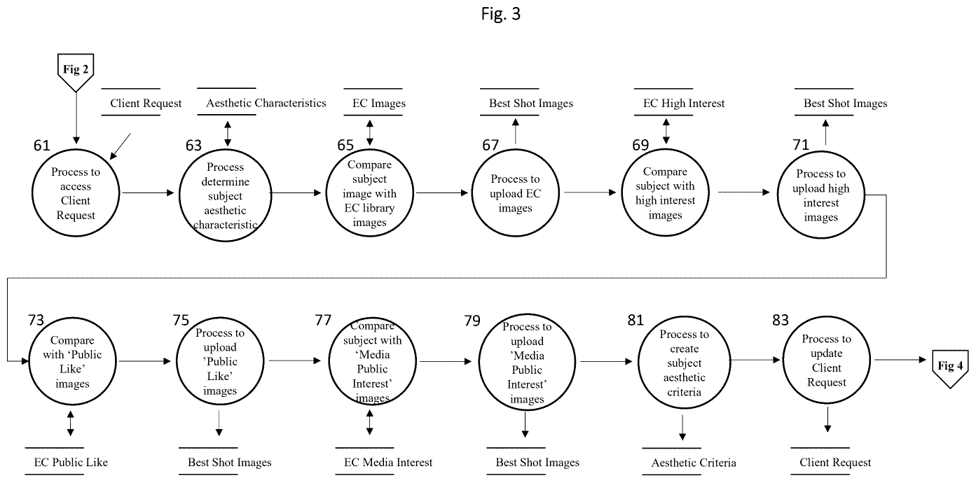

### FIG. 3: Method for Determining the Aesthetic Characteristics of an Image or Video of a Subject

As illustrated in FIG. 3, this method comprises a plurality of sub-methods or sub-processes, as set forth below, for determining the aesthetic characteristics of the image of video of a subject.
a. Accessing the Client Request, specifically data related to location and environment as these may impact the aesthetic characteristics of the image or video. (61)
b. Determining Client-defined aesthetic characteristics for an image of a subject. The aesthetic characteristics include, but are not limited to, the rule of thirds, leading lines, symmetry within in an image, use of color, framing an image, composition within an image, and high viewer interest in an image. (63)
c. Accessing data and images based on the Client Request (61)
d. Identifying EarthCam-defined proprietary aesthetic characteristics.
e. Comparing a subject image with images including, but not limited to including EarthCam proprietary images, EarthCam archived images, news media images, and viral sourced images as stored in the EC Images Docu-Vault of the same, but not necessarily the same, subject. Establishing image selection criteria and rubrics for selecting one or more images from among the images stored in the EC Images Docu-Vault, wherein the selection of the one or more images is based on a selection criterion and the rubric scores. (65)
f. Uploading a copy of the one or more images selected from the EC Images Docu-Vault images to the Best Shot Images Docu-Vault. The step of uploading the one or more selected images to the Best Shot Images Docu-Vault segregates these images from all other images in the EC Images Docu-Vault, thereby providing more efficient and faster image processing during subsequent steps. (67)
g. Comparing the subject image with stored images of the same subject or a similar subject, wherein the images are stored in an EC High Interest Docu-Vault. EarthCam had identified certain images as having high public interest and stored those images in the EC High Interest Docu-Vault. In addition to comparing, this step involves establishing image selection criteria and rubrics for image selection. Finally, selecting one or more images from the EC High Interest Docu-Vault according to the rubrics. (69)
h. Uploading a copy of the images selected from the EC High Interest Docu-Vault to the Best Shot Images Docu-Vault. This step of copying an image from the EC High Interest Docu-Vault segregates the images from all other images in the EC High Interest Docu-Vault, allowing for a more efficient and faster image processing. (71)
i. Comparing the subject image with stored images of the same subject or similar subjects, wherein the images were made available to EarthCam and stored in the EC Public Like Docu-Vault as they have a high public ‘like’ ratings. In addition to comparing, this step involves establishing selection criteria and rubrics for image selection based on the selection criterion. Finally, selecting one or more images from the EC Public Like Docu-Vault according to the rubrics. (73)
j. Uploading a copy of the images selected from the EC Public Like Docu-Vault to the Best Shot Images Docu-Vault. Copying an image to the Best Shots Images Docu-Vault segregates the image from all other images in the EC Public Like Docu-Vault, allowing for a more efficient and faster image processing. (75)
k. Comparing the subject image with images of the same or a similar object stored in the EC Media Interest Docu-Vault. These stored images having been used in a public broadcast or other media and achieved a high public interest. This step also involves establishing image selection criteria and rubrics for selecting one or more images from the EC Media Interest Docu-Vault. Finally, selecting one or more images from the EC Media Interest Docu-Vault according to the rubrics. (77)
l. Uploading a copy of the images selected from an EC Media Interest Docu-Vault to the Best Shot Images Docu-Vault. Copying an image to the Best Shots Images Docu-Vault segregates the image from all other images in the EC Media Interest Docu-Vault, allowing for a more efficient and faster image processing. (79)
m. Creating subject aesthetic criteria. (81)
n. Updating the Client Request with image selection, image selection identification, image selection criteria and image selection rubrics, as related to the sub-methods of FIG. 3. (83)

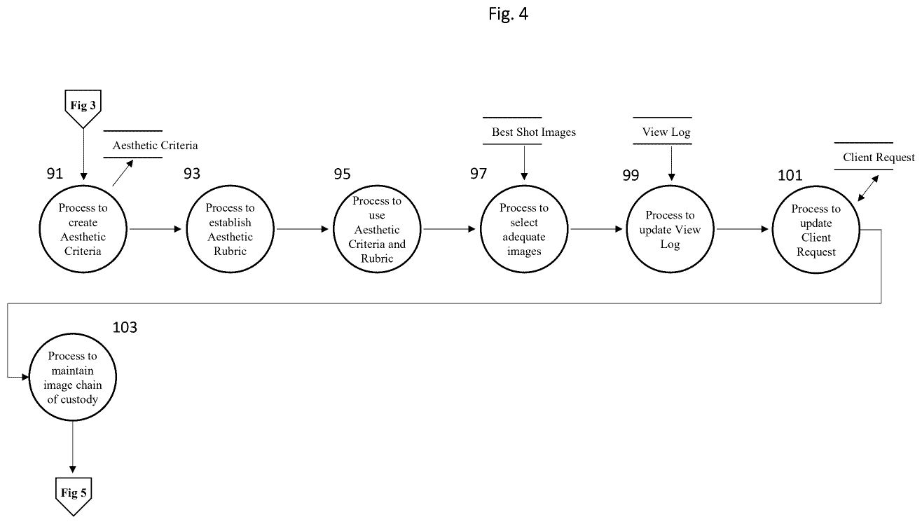

### FIG. 4: Method for Determining if the Aesthetic Characteristics of the Image or the Video are Adequate

As illustrated in FIG. 4, this method comprises a plurality of sub-methods or sub-processes, as set forth below, for determining if the image or the video aesthetic characteristics are adequate.
a. Creating aesthetic criteria for use in determining if the image or video aesthetic characteristics are adequate. (91)
b. Establishing an aesthetic rubric to determine if the image or video aesthetic characteristics are adequate. (93)
c. Using the aesthetic criteria and the aesthetic rubric, determining if the image or video aesthetic characteristics are adequate. (95)
d. Selecting images that are deemed adequate and uploading them to the Best Shot Images Docu-Vault. (97)
e. Updating the View Log with results of the aesthetic rubric. (99)
f. Updating the Client Request. (101)
g. Maintaining a chain of custody for images selected in d. (103)

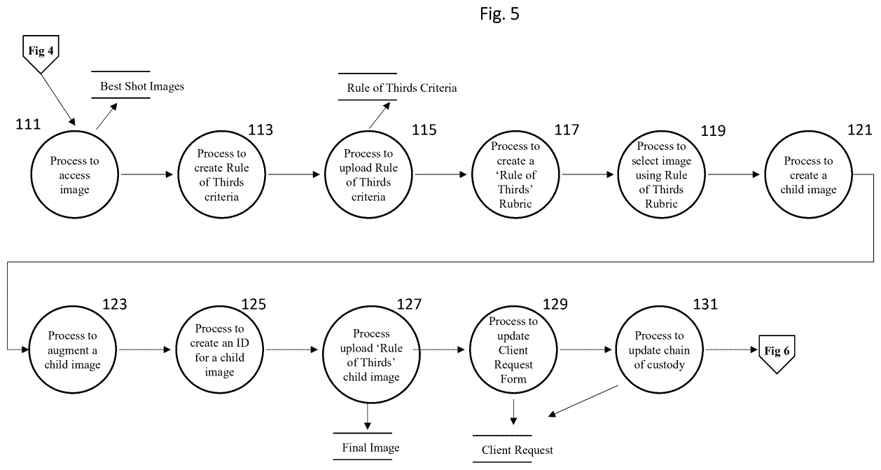

### FIG. 5: Method for Determining the ‘Rule of Thirds’ Within an Image or Video

As illustrated in FIG. 5, this method comprises a plurality of sub-methods or sub-processes, as set forth below, for determining the “rule of thirds” within an image.
a. Retrieving an image from the Best Shot Docu-Vault for evaluating the image relative to a Rules of Thirds criteria. (111)
b. Creating a ‘Rule of Thirds’ criteria. (113)
c. Uploading the ‘Rule of Thirds’ criteria to a ‘Rule of Thirds’ Docu-Vault. (115)
d. Creating a ‘Rule of Thirds’ rubric for use in grading an image relative to the ‘Rule of Thirds’ criteria. (117)
e. Evaluating the image retrieved at step a. based on at least the ‘Rule of Thirds’ criteria and determining a Rule of Thirds' rubric score. (119)
f. Creating a child image of the image retrieved at step a. (121)
g. Augmenting the child image to improve the aesthetic characteristics of the image based on the Rule of Thirds criteria, while maintaining the integrity of the parent image as the parent image is not augmented. (123)
h. Creating an ID for the augmented child image and associating the augmented child image with the parent image. (125)
i. Uploading the augmented child image to a Final Image Docu-Vault. (127)
j. Updating the Client Request relative to the method associated with the ‘Rule of Thirds.” (129)
k. Updating the chain of custody of the augmented child image in the Client Request. (131)

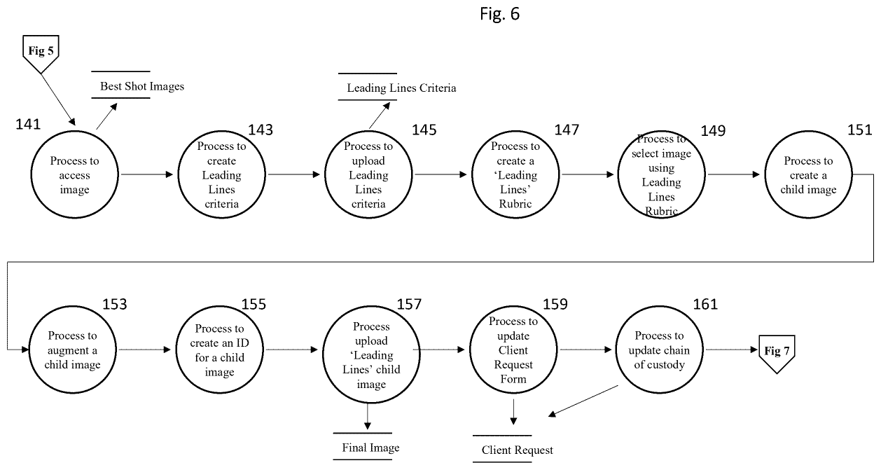

### FIG. 6; Method for Determining the ‘Lead Lines’ Within an Image or Video

As illustrated in FIG. 6, this method comprises a plurality of sub-methods or sub-processes, as set forth below, for determining the ‘lead lines’ within an image.
a. Retrieving an image from the Best Shot Docu-Vault for evaluating the image relative to a Lead lines criteria within the image. (141)
b. Creating a ‘Lead Lines’ criteria. (143)
c. Uploading the ‘Lead Lines’ criteria to a ‘Lead lines’ Docu-Vault. (145)
d. Creating a ‘Lead Lines’ rubric for use in grading an image relative to the ‘Lead Lines’ criteria. (147)
e. Evaluating the image selected at step a. based on at least the ‘Lead Lines’ criteria and determining a Lead lines' rubric score. (149)
f. Creating a child image of the image retrieved at step a. (151)
g. Augmenting the child image to improve the aesthetic characteristics of the image based on a ‘Lead Lines’ criteria, while maintaining the integrity of the parent image as the parent image is not augmented. (153)
h. Creating an ID for the augmented child image and associating the augmented child image with the parent image. (155)
i. Uploading the augmented child image to the Final Image Docu-Vault. (157)
j. Updating the Client Request relative to the method associated with the ‘Lead Lines’. (159)
k. Updating the chain of custody of the augmented child image. (161)

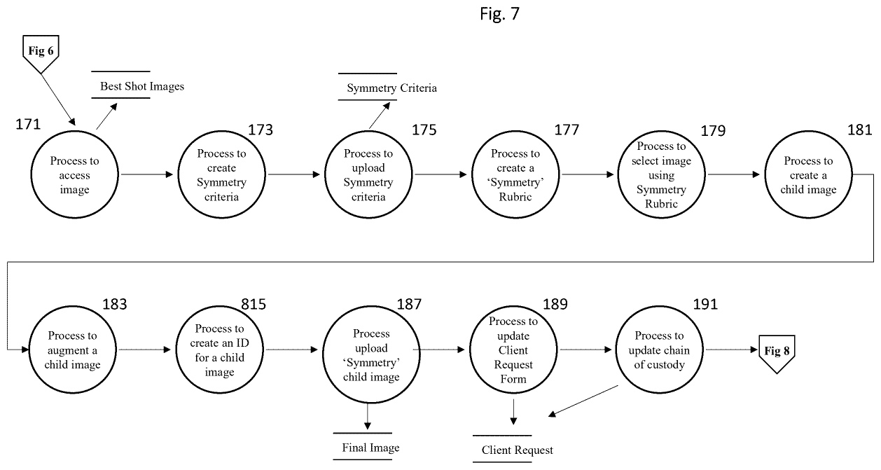

### FIG. 7; Method for Determining the ‘Symmetry’ Within an Image or Video

As illustrated in FIG. 7, this method comprises a plurality of sub-methods or sub-processes, as set forth below, for determining the symmetry within an image.
a. Retrieving an image from the Best Shot Docu-Vault for evaluating the image relative to the symmetry within the image. (171)
b. Creating a ‘Symmetry’ criteria. (173)
c. Uploading ‘Symmetry’ criteria to a ‘Symmetry’ Docu-Vault. (175)
d. Creating a ‘Symmetry’ rubric for use in grading an image relative to the ‘Symmetry’ criteria. (177)
e. Evaluating the image selected at step a. based on the ‘Symmetry’ criteria and determining a Symmetry’ rubric score. (179)
f. Creating a child image of the image retrieved at step a. (181)
g. Augmenting the child image based on the ‘Symmetry’ criteria to improve the aesthetic characteristics of the image, while maintaining the integrity of the parent image as the parent image is not augmented. (183)
h. Creating an ID for the augmented child image and associating the child image with the parent image. (185)
i. Uploading, the augmented child to the Final Image Docu-Vault. (187)
j. Update the Client Request relative to the method associated with the ‘Symmetry.” (189)
k. Updating the chain of custody for the augmented child image. (191)

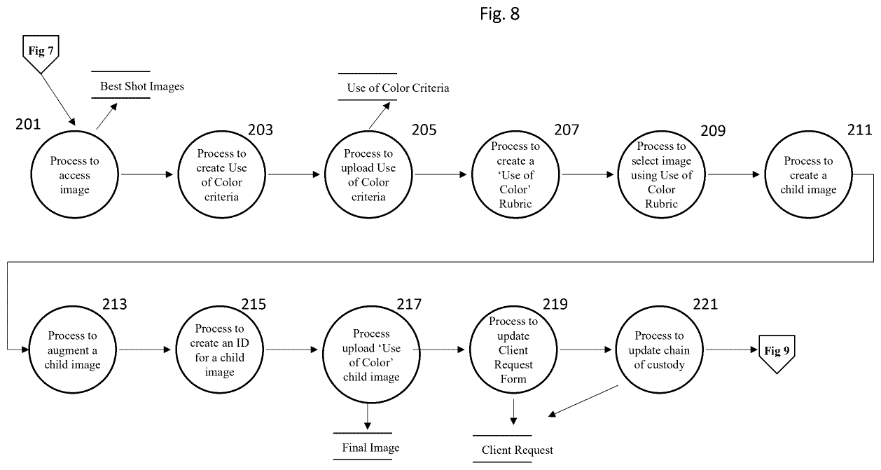

### FIG. 8: Method for Determining the ‘Use of Color’ Within an Image or Video

As illustrated in FIG. 8, this method comprises a plurality of sub-methods or sub-processes, as set forth below, for determining the ‘Use of Color’ within an image.
a. Retrieving an image from the Best Shots Docu-Vault for evaluating the image relative to the use of color within the image. (201)
b. Creating a ‘Use of Color’ criteria. (203)
c. Uploading ‘Use of Color’ criteria to a ‘Use of Color’ Docu-Vault. (205)
d. Creating a ‘Use of Color’ rubric for use in grading an image relative to the ‘Use of Color’ criteria. (207)
e. Evaluating the image retrieved at step a. based at least in part on the ‘Use of Color’ criteria and determining a ‘Use of Color’ rubric score. (209)
f. Creating a child image of the image at step a. (211)
g. Augmenting the child image to improve the aesthetic characteristics of the image based on the ‘Use of Color’ criteria, while maintaining the integrity of the parent image as the parent image is not augmented. (213)
h. Creating an ID for the augmented child image and associating the augmented child image with the parent image. (215)
i. Uploading the augmented child image to the Final Image Docu-Vault. (217)
j. Updating the Client Request with relative to the method associated with the ‘Use of Color’. (219)
k. Updating the chain of custody of the augmented child image. (221)

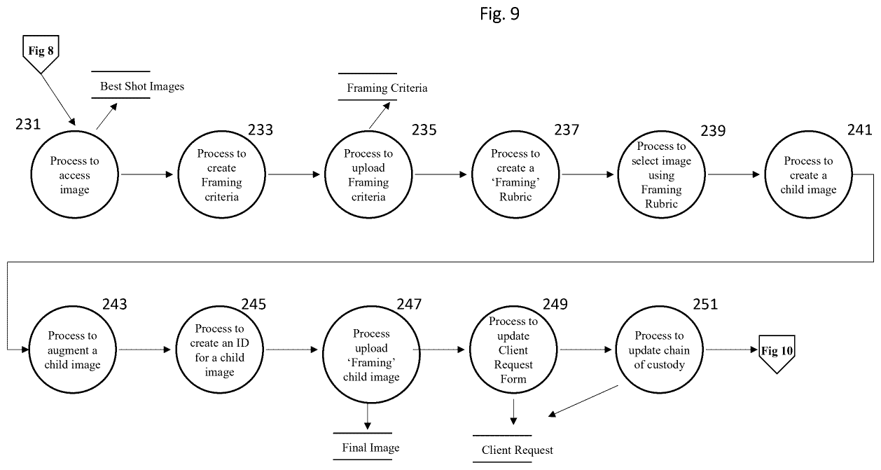

### FIG. 9: Method for Determining ‘Framing’ Within an Image or Video

As illustrated in FIG. 9 this method comprises a plurality of sub-methods or sub-processes, as set forth below, for determining framing within an image.
a. Retrieving an image from the Best Shot Docu-Vault for evaluating the image relative to framing characteristics of the image. (231)
b. Creating ‘Framing’ criteria. (233)
c. Uploading the ‘Framing’ criteria to a ‘Framing’ Docu-Vault. (235)
d. Creating, a ‘Framing’ rubric for use in grading an image relative to the ‘Framing’ criteria. (237)
e. Evaluating the image selected at step a. based on at least the ‘Framing’ criteria and the ‘Framing’ and determining a ‘Framing’ rubric score. (239)
f. Create a child image of the image retrieved at step a. (241)
g. Augmenting the child image to improve the aesthetic characteristics of the image based on the ‘Framing’ criteria, while maintaining the integrity of the parent image as the parent image is not augmented. (243)
h. Creating an ID for the augmented child image and associating the augmented child image with the parent image. (245)
i. Uploading, the augmented child image to the Final Image Docu-Vault. (247)
j. Updating the Client Request relative to the method associated with the ‘Framing’. (249)
k. Updating the chain of custody of the augmented child image. (251)

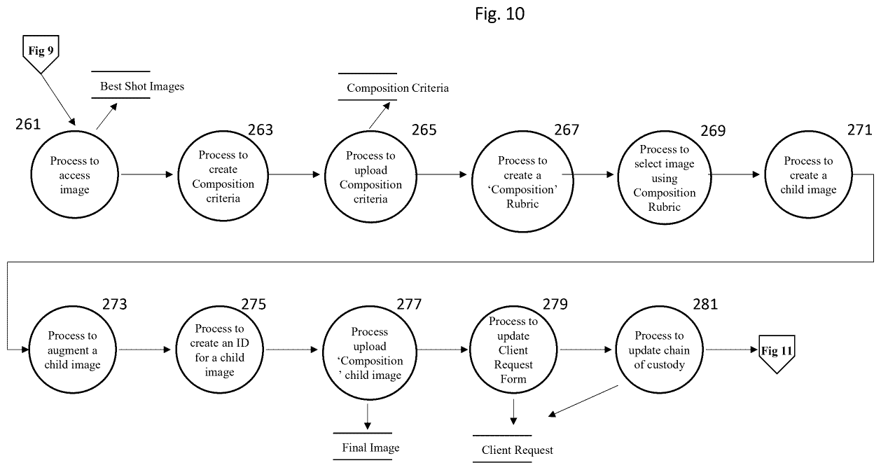

### FIG. 10: Method for Determining the ‘Composition’ of an Image or Video

As illustrated in FIG. 10, this method comprises a plurality of sub-methods or sub-processes, as set forth below, for determining the composition of an image.
a. Retrieving an image from the Best Shot Docu-Vault for evaluating the image relative to the ‘Composition’ characteristics of the image. (261)
b. Creating ‘Composition’ criteria for an image. (263)
c. Uploading the ‘Composition’ criteria to the ‘Composition’ Docu-Vault. (235)
d. Creating a ‘Composition’ rubric for use in grading an image relative to the ‘Composition’ criteria. (267)
e. Evaluating the image selected at step a. based at least in part on the ‘Composition’ criteria and determining a ‘Composition’ rubric score. (269)
f. Creating a child image of the image selected at step a. (271)
g. Augmenting the child image to improve the aesthetic characteristics of the child image based on the ‘Composition’ criteria, while maintaining the integrity of parent image as the parent image is not augmented. (273)
h. Creating an ID for the augmented child image and associating the augmented child image with the parent image. (275)
i. Uploading the augmented child image to the Final Image Docu-Vault. (277)
j. Updating the Client Request relative to the method associated with the ‘Composition’. (279)
k. Updating the chain of custody of the augmented child image. (281)

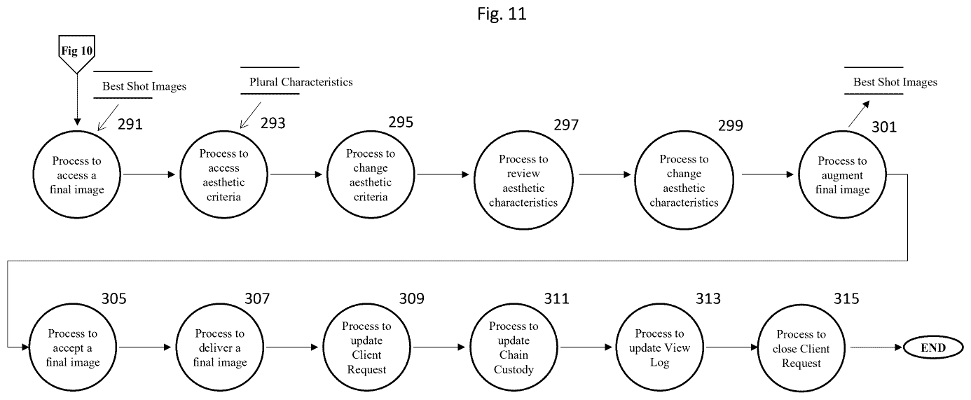

### FIG. 11: Method to Revise and Accept a Final Image or Video of a Subject

As illustrated in FIG. 11, this method comprises a plurality of sub-methods or sub processes, as set forth below, for revising and accepting the final image of a subject.
a. Accessing a final image of a subject from a Best Shot Images Docu-Vault. (291)
b. Accessing aesthetic criteria, rule of thirds criteria, lead lines criteria, symmetry criteria, use of color criteria, framing criteria, and composition criteria. (293)
c. Changing one or more of, aesthetic criteria, rule of thirds criteria, lead lines criteria, symmetry criteria, use of color criteria, framing criteria, composition criteria. (295)
d. Reviewing aesthetic characteristics for possible changes. (297)
e. Changing the aesthetic characteristics to create a Best Shot final image. (301)
f. Augmenting the subject image based on the changed criteria and aesthetic characteristics and uploading an augmented final image to a Best Shot Images Docu-Vault. (303)
g. A Client accepting a final image of the subject. (305)
h. Delivering the final image of the subject to a Client. (307)
i. Updating the Client Request to reflect the final image. (309)
j. Updating the chain of custody of the image. (311)
k. Updating the View Log (313)
l. Closing the Client Request for the Best Shot.

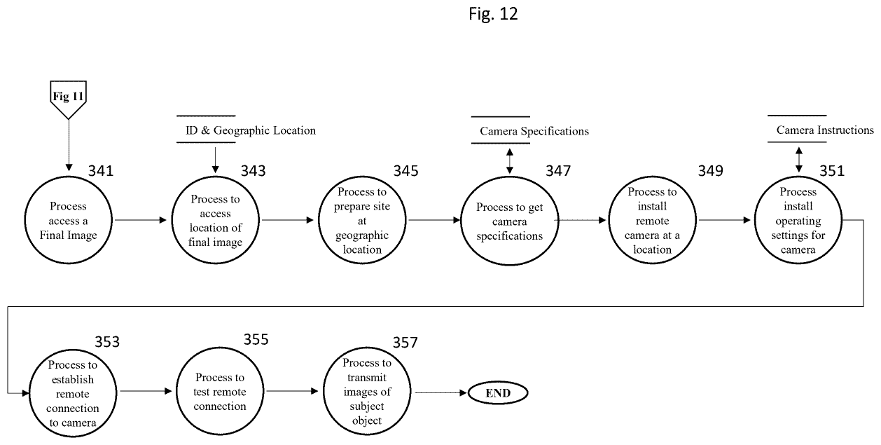

### FIG. 12: Method to Locate a Stationary Camera Based on an Accepted Final Image or Video of the Subject

As illustrated in FIG. 12, this method comprises a plurality of sub-methods or sub-processes, as set forth below, locating a stationary camera based on an accepted final image or video or a subject.
a. Accessing the final image of the subject. (341)
b. Accessing information as to the geographic location and elevation of the subject and the time and date when the image was taken.
c. Accessing information as to the geographic location and elevation of the remote camera. And accessing the compass heading of the camera lens in terms of degrees relative to north. (343)
d. Preparing a site for a stationary camera at the intended geographic location of the camera, including but not limited to, securing the required licenses as required by local regulatory requirements and a site lease, obtaining camera mounts, arranging for the provision of power, communication, and standby power to the site. (345)
e. Acquiring hardware, software, firmware and power specifications for the remote camera. (347)
f. Installing the remote camera at a specific geographic location to capture images of a subject. (349)
g. Installing an operating instruction set for the remote camera including, but not limited to, frequency of capturing images, schedule for capturing images, horizontal and vertical panning, camera settings, schedule for transmitting images to the remote Docu-vault, and frequency for transmitting images to the remote Docu-vault. (351)
h. Establishing a remote communications connection from a remote operator to the camera. (355)
i. Testing the remote communication connection between the remote operator and the camera. (357)
j. The camera transmitting images of the subject to the Docu-Vault. (357)

To create a “best shots” image according to the invention, rubric scores are calculated for an image of a subject (referred to herein as an initial image) for one or more of the image characteristics described herein, e.g. leading lines criteria, symmetry criteria, framing criteria, camera parameters.

Next a curated image is selected from among the image sources described herein, e.g., high interest images, public like images, media public interest images. Preferably the selected curated image is an image of the subject or an object similar to the subject. Here too a rubric score is calculated for the curated image. Preferably these rubric scores are calculated for the same criteria according to the same rubrics that had been used to calculate the rubric scores for the initial image.

In lieu of selecting a curated image and determining its rubric score for selected image characteristics, desired rubric scores for one or more selected image characteristics can be determined without reference to a specific curated image. In this situation, professionals (persons of skill) in the photographic and image evaluation art identify important image characteristics and develop an associated rubric and an associated rubric score for each characteristic. These characteristics and rubric scores are then considered to be indicative of a “best shot” image.

The rubric scores for the initial image and the rubrics scores for the curated image (or the rubric scores as determined by professionals) are compared, with the objective of moving the rubric scores for the initial image closer to the rubric scores for the curated image. In particular, increasing the rubric score for the initial image.

Image characteristics for the initial image can be modified by changing the leading lines characteristic, for example, of the initial image. Upon changing the leading lines characteristic, the new image is referred to as a child image, as described herein. According to a preferred embodiment, it is important that no changes or augmentations are made to the initial image. Instead, a child image is created (as a direct copy of the initial image) and modifications and augmentations are created in the child image. This technique preserves the integrity of the initial image and ensures that an accurate chain of custody is maintained for both the initial image and the child image.

The leading lines rubric is recalculated for the child image. Specifically, all the image characteristics that were evaluated and scores calculated before generating the child image, are recalculated and compared, again, to the respective rubric scores of the curated image.

The process of modifying image characteristics, recalculating rubric scores for the child image(s), and comparing the calculated child image rubric scores with the curated image rubric scores continues until the child image rubric scores are within a predetermined differential of the curated image rubric scores or until the process has iterated a predetermined number of times. At which point the last child image is considered the final child image and the process terminates.

One embodiment of the invention designates certain image characteristics and a sum of the associated rubric scores above a predetermined value for those image characteristics to be indicative of an aesthetically pleasing image.

The invention thus includes a method to determine whether an initial image is considered aesthetically pleasing. Although “aesthetically pleasing” may be considered a subjective determination, the initial image can be evaluated based on characteristics that are generally considered to be aesthetically pleasing. Rubric scores are determined for each such characteristic, and a total rubric score is calculated by simply combining the individual rubric scores. If the total rubric score for the child image is greater than the rubric score indicative of an aesthetically pleasing image, then the child image is considered to be aesthetically pleasing.

Of course, the initial image may undergo multiple revisions, according to various image characteristics as set forth herein, before the total rubric score indicates an aesthetically pleasing image.

As related to yet another embodiment of the invention, Assignee of the present invention has placed remotely controlled cameras at various interesting locations around the world. For example, cameras are located at Times Square in New York City, overlooking the Grand Canyon, and even at a local pub in Dublin, Ireland. The camera real-time images (whether still images or videos) are displayed on Assignees website for all to enjoy.

Of course, one important objective is to ensure each camera provides an interesting real time image on the Assignee's website. If, for any reason, an image is deemed not so interesting, the camera is remotely controlled to generate a more interesting image. Shadowed images, that is, a shadow covering all or a portion of the image subject, typically result in a dark image that is clearly not very interesting.

Since the cameras are remotely controlled, the user remotely contacts and controls each camera with the objective of producing an interesting captured image. The system can call up any camera and show what is currently happening in New York City, Dublin, Ireland, or the Grand Canyon, for example. With remote control over these cameras, any camera can be tilted, or panned or zoomed to ensure that an interesting image has been captured.

The primary condition that must be considered for a quality image relates to the presence (ideally the absence) of shadows that might appear in the image and mask or cover the subject of the image. Of course, these shadows render the image less than ideal. It is known that a high-quality image generally requires the sun behind the camera to illuminate the image subject.

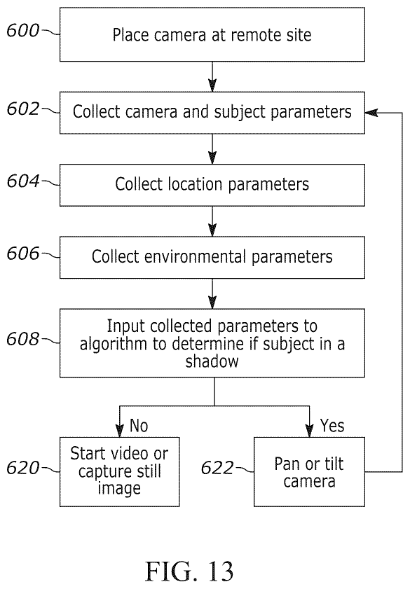

A method for ensuring shadowless images is depicted in FIG. 13 where a camera (video or still) is placed at step 600 and certain parameters are collected at steps 602 (camera and subject parameters), 604 (location parameters), and 606 (environmental parameters).

To determine the expected shadow conditions, an algorithm analyzes the following image factors and camera factors to determine whether the subject will be within a shadow and therefore produce an undesirable image.

At step 608, the algorithm of a present invention evaluates the following parameters: compass direction of a line from the camera lens to the subject, camera field of view, identification of the subject, camera lens angle relative to the subject, camera location in terms of latitude and longitude, camera settings (e.g., f stop, shutter speed, white balance, exposure duration) current date and time of day (assuming the image will be captured when the time of day sis determined), location of the subject, time zone where the camera and subject are located, direction the camera and the subject are facing, height of the camera and height of the subject above some known reference point, position of the camera and subject, and various environmental conditions that may also affect the image quality.

These environmental parameters include, but are not limited to, seasonal weather conditions and current weather conditions (e.g., presence of fog or rain). The environmental conditions can be determined by appropriate sensors at the camera and/or subject site and data representing those conditions transmitted from the camera site to a location where the algorithm is executed.

With the input data as set forth herein, the algorithm determines whether an image will be in a shadow or conversely, whether the subject will be bathed in sufficient light to produce a high-quality image. In the event the algorithm determines the subject will be eclipsed by a shadow, the camera is automatically tilted or panned to capture a different image. See step 622 along an affirmative branch from a decision step 608 of FIG. 13.

And the data collections steps are repeated as processing returns to step 602, as shown in FIG. 13 after panning and/or tilting the camera. The new tilt and pan angles and the collected data are input to the algorithm and the algorithm will again determine whether the camera and subject will be in a shadow or in sunlight.

If the algorithm determines that the subject is not in a shadow processing moves from the algorithm processing step 608 to step 620 where the video capture or recording is started or a sill photograph is taken.

In addition to avoiding shadow effects as described above, another algorithm can also evaluate a candidate image (that is, before the shutter is opened to capture the still image or video) relative to the following image characteristics: aesthetic characteristics, artistic characteristics, rule of thirds characteristics, leading lines characteristics, image symmetry characteristics, color characteristics, framing characteristics, and composition characteristics.

Upon determining that one or more of these aesthetic/artistic characteristics is not sufficient, by evaluating a rubric or comparing to a known good image in one embodiment (a curated image, for example) as discussed herein, the camera pan, tilt, and zoom parameters are modified by remote control to improve the candidate image before the shutter is snapped.

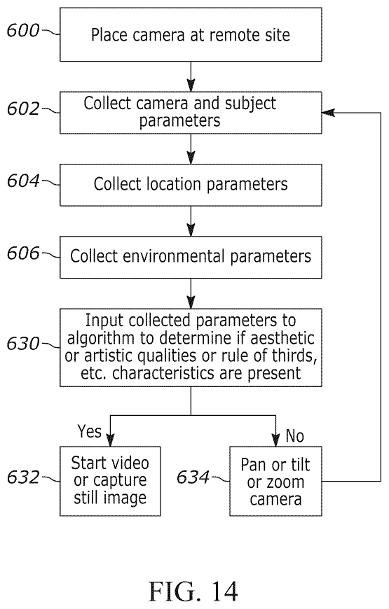

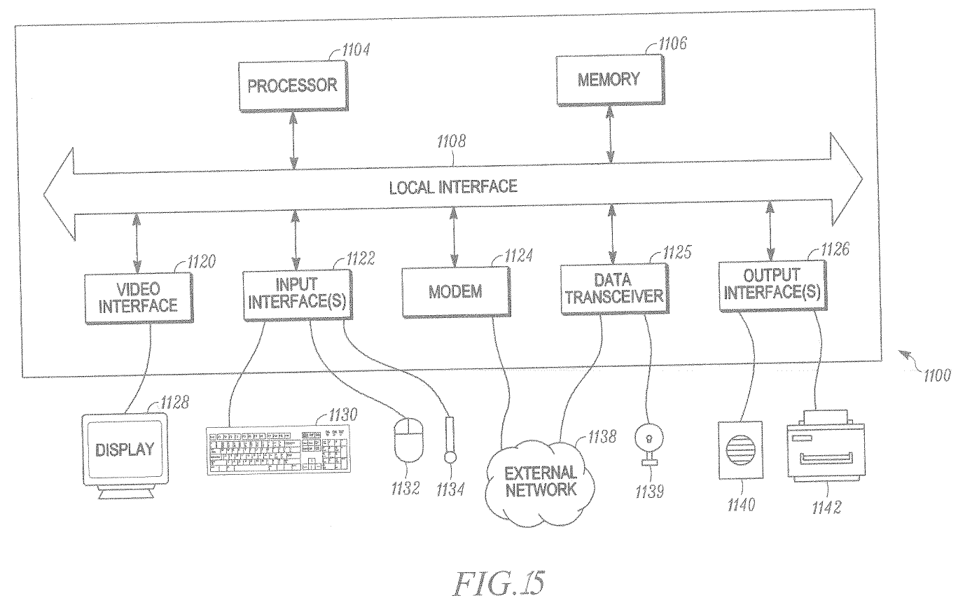

See FIG. 14. Steps 600, 602, 604, and 606 indicate actions as discussed above. At step 630 an algorithm evaluates the collected parameters to determine whether the subject image displays sufficient artistic and/or aesthetic qualities.

An affirmative answer moves processing to step 632 where the video capture or recording is started or a still image is captured.

A negative answer moves processing to step 634 where the camera is panned or tilted or zoomed to improve the artistic and/or aesthetic characteristics of the image, after which processing returns to step 602 to repeat the data collection processes at the new pan/tilt/zoom settings.

Frequent reference is made herein to images, photographs, still photographs, and videos. Those skilled in the art are aware that the teachings of the invention can be applied to all photographic images and video images to improve the artistic and aesthetic characteristics thereof.

What is claimed is:

1. A method for improving an initial image of a subject, comprising:
analyzing the initial image relative to at least one image characteristic;
responsive to a step of analyzing, determining an image rubric score for the initial image for the at least one image characteristic;
if the image rubric score is below a predetermined rubric score threshold, producing a copy of the initial image and creating a child image by modifying the at least one image characteristic of the copy of the initial image to reduce a differential between the image rubric score and the predetermined rubric score threshold; and
associating the child image with the initial image and updating a chain of custody record responsive thereto.

2. The method of claim 1, wherein the initial image comprises a still photograph of an object or a video associated with an object.

3. The method of claim 1, further comprising, determining an image total rubric score that includes a rubric score for each one of a plurality of image characteristics, and modifying one or more of the plurality of image characteristics to increase the image total rubric score.

4. The method of claim 1, wherein the predetermined rubric score threshold is determined by analyzing the at least one image characteristic of one or more archived images, wherein the archived images comprise proprietary images, news media images, viral-sourced images, high-interest images, public-like images, and media interest images, and determining the predetermined rubric score threshold responsive to a step of analyzing.

5. The method of claim 1, wherein the at least one image characteristic is determined by a user of the method or by a third party who has requested execution of the method to obtain the child image of the subject.

6. The method of claim 1, wherein the child image is intended for use by a client and wherein the client determines the at least one image characteristic.

7. The method of claim 1, wherein image characteristics comprise: aesthetic characteristics, artistic characteristics, rule of thirds characteristics, leading lines characteristics, image symmetry characteristics, color characteristics within an image, framing characteristics of an image, and composition characteristics of an image.

8. The method of claim 1, wherein image characteristics are caused by one or more parameters of a camera that captured the image and one or more conditions of an environment of the subject when the initial image was captured.

9. The method of claim 8, wherein the camera comprises a still camera or a video camera.

10. The method of claim 8, wherein the one or more parameters of the camera or the one or more conditions of the environment comprise: camera compass direction, camera field of view, camera geo location, camera height above sea level, identification of the subject image, geographic location of the subject image, compass direction of subject image, camera lens angle relative to the subject image, date and time when photograph or video of the subject image was taken, environmental and weather conditions when photograph or video of subject image was taken, seasonal weather patterns at camera location, current weather conditions at a time when subject image was taken, sun position, best position of the camera, direction of the camera lens and angle of the camera lens relative to the subject and the sun.

11. The method of claim 1, further comprising storing one or both of the initial image and the child image in a secure datastore.

12. The method of claim 1, wherein the child image is considered a best shot image of the subject.

13. A method for revising an initial image of a subject to improve an image characteristic, the method comprising:
wherein the initial image comprises a still photograph or video of the subject;
analyzing the initial image relative to the image characteristic;
responsive to a step of analyzing, determining an image rubric score for the initial image for the image characteristic;
accessing a database of archived images;
identifying archived images of the subject or an object similar to the subject within the database;
responsive to a step of identifying, determining a rubric score for each one of the archived images for the image characteristic;
selecting an archived rubric score from among the rubric scores for each one of the archived images for the image characteristic;
comparing the image rubric score and the archived rubric score; and
producing a child image by modifying the initial image to reduce a differential between the image rubric score and the archived rubric score.

14. The method of claim 13, further comprising associating the child image with the initial image and updating a chain of custody record responsive thereto.

15. The method of claim 13, wherein a step of producing a child image further comprises producing a copy of the initial image and producing the child image by modifying the image characteristic of the copy of the initial image to reduce the differential between the image rubric score and the archived rubric score.

16. A method for revising a still photograph or video of an initial image of a subject to improve an image characteristic of the still photograph or video of the subject, the method comprising:
a. analyzing the initial image relative to the image characteristic;
b. responsive to step a. determining an image rubric score related to the image characteristic for the initial image;
c. if the image rubric score determined at step b. is below a predetermined rubric score, producing a copy of the initial image and creating an intermediate child image by revising the image characteristic of the intermediate child image;
d. analyzing the intermediate child image relative to the image characteristic;
e. responsive to a step d. determining a rubric score for the intermediate child image for the image characteristic;
f. upon determining that the rubric score for the intermediate child image as determined at a step e. is below the predetermined rubric score modifying the image characteristic of the intermediate child image, repeating steps d. through f. until the rubric score for the intermediate child image satisfies the predetermined rubric score or until a predetermined number of iterations have occurred;
g. wherein an intermediate child image that satisfies the predetermined rubric score according to a step f. is considered the final child image or wherein the predetermined number of iterations have occurred and a most recent child image is considered the final child image; and
h. associating the final child image with the initial and updating a chain of custody record responsive thereto.

17. A method for controlling a remote camera to capture a quality image of a subject, the method comprising:
a. collecting one or more of camera parameters, subject parameters, location parameters, and environmental parameters;
b. inputting the parameters collected at step a. into an algorithm, wherein the algorithm determining characteristics of an image of the subject;
c. wherein if the algorithm determines that the image or a portion of the image is in a shadow, adjusting one or more of the pan or tilt configurations of the camera;
d. repeating steps a. through c. until the algorithm determines that the image or a portion of the image is not in a shadow, then proceeding to step e.; and
e. controlling the camera to capture the image.

18. The method of claim 17, wherein the image comprises a still image or a video.

19. The method of claim 17, wherein the camera, subject, and location parameters comprise: compass direction of a line from the camera lens to the subject, camera field of view, identification of the subject, camera lens angle relative to the subject, camera location in terms of latitude and longitude, camera settings further comprising, f stop, shutter speed, white balance, exposure duration, a current date and time of day, location of the subject, time zone where the camera and the subject are located, direction in which the camera and the subject are facing, height of the camera and height of the subject above a known reference point, position of the camera and the subject.

20. The method of claim 17, wherein the environmental parameters comprise:
seasonal weather conditions and current weather conditions.

21. A method for controlling a remote camera to capture a quality image of a subject, the method comprising:
a. collecting one or more of camera parameters, subject parameters, location parameters, and environmental parameters;
b. inputting the parameters collected at step a. into an algorithm, wherein the algorithm determining characteristics of an image of the subject;
c. wherein if the algorithm determines that the image artistic and aesthetic characteristics are below a minimum score, adjusting one or both of the pan or tilt configurations of the camera;
d. repeating steps a. through c. until the algorithm determines that the image artistic and aesthetic characteristics are above the minimum score, then proceeding to step e.; and
e. controlling the camera to capture the image.

22. The method of claim 21, wherein the artistic and aesthetic characteristics comprise one or more of, rule of thirds, symmetry, color, framing of objects, composition, and lead lines.
